(19) United States
(12) Patent Application Publication
(10) Pub. No.: US 2025/0208156 A1
(43) Pub. Date: Jun. 26, 2025

(54) INTEGRATED CENTRALIZED AND DECENTRALIZED OPERATION OF AUTOMATED DIAGNOSTIC ANALYSIS SYSTEMS AND METHODS THEREOF

(71) Applicant: Siemens Healthcare Diagnostics Inc., Tarrytown, NY (US)

(72) Inventors: Rayal Prasad, Princeton, NJ (US); Boris Mailhe, Plainsboro, NJ (US); Ankur Kapoor, Plainsboro, NJ (US)

(73) Assignee: Siemens Healthcare Diagnostics Inc., Tarrytown, NY (US)

(21) Appl. No.: 18/842,651

(22) PCT Filed: Mar. 2, 2023
(86) PCT No.: PCT/US2023/063624

§ 371 Date: Aug. 29, 2024

Related U.S. Application Data
(60) Provisional application No. 63/268,908, filed on Mar. 4, 2022.

(51) Int. Cl. G01N 35/04; G01N 35/00

(52) U.S. Cl. CPC G01N 35/04; G01N 35/00613; G01N 35/00871

(57) ABSTRACT

An automated diagnostic analysis system includes a system controller for system-wide workflow planning and execution of sample analyses and also includes decentralized processing capabilities (e.g., one or more second controllers) for determining a work-around, where possible, to a detected fault affecting an analysis of a particular sample. The system controller communicates with system components via a first communication channel, while the second controller communicates with a subset of the system components via a second communication channel. Where a work-around for a detected fault cannot be determined by the second controller, the detected fault is communicated to the system controller for resolution. Methods of operating an automated diagnostic analysis system are also provided, as are other aspects.

### CROSS REFERENCE TO RELATED APPLICATION

This application claims the benefit of U.S. Provisional Patent Application No. 63/268,908, entitled “INTEGRATED CENTRALIZED AND DECENTRALIZED OPERATION OF AUTOMATED DIAGNOSTIC ANALYSIS SYSTEMS AND METHODS THEREOF” filed Mar. 4, 2022, the disclosure of which is hereby incorporated by reference in its entirety for all purposes.

### FIELD

This disclosure relates to automated diagnostic analysis systems and methods.

### BACKGROUND

In medical testing, automated diagnostic analysis systems may be used to analyze a biological sample to identify an analyte or other constituent in the sample. The biological sample may be, e.g., urine, whole blood, blood serum, blood plasma, interstitial liquid, cerebrospinal liquid, and the like. Such biological samples are usually contained in sample containers (e.g., test tubes, vials, etc.) that may be transported in sample carriers via a sample transport system comprising automated tracks to and from various modules. The various modules may perform, e.g., sample container handling, sample pre-processing, sample analysis, and sample post-processing within an automated diagnostic analysis system.

A system controller of an automated diagnostic analysis system may perform workflow planning. That is, the system controller may receive information regarding an analysis to be performed on each sample, select and direct one or more modules to perform various actions related to the analysis of each sample, and direct each sample carrier transporting a sample container thereon to and from the selected modules via the sample transport system. Workflow planning may also include resolution of various faults that may occur during operation of the automated diagnostic analysis system, such as, e.g., a module malfunction, a sample carrier malfunction, a track segment malfunction, and/or sample carrier track congestion. Such faults may occur simultaneously or very close in time. A system controller may lose efficiency as it attends to resolution of each fault as it occurs. This may result in sample processing delays that may adversely affect overall system performance (e.g., the number of samples analyzed per hour, per shift, per day, etc.).

Accordingly, improved workflow planning in an automated diagnostic analysis system is desired.

### SUMMARY

In some embodiments, an automated diagnostic analysis system is provided. The system includes a first sample carrier operative to communicate using a first communication channel and a second communication channel. The first sample carrier is configured to carry a first sample container. The system also includes a first module operative to communicate using the first communication channel and the second communication channel. The first module is configured to perform an action on a sample container or a liquid contained in the sample container. The system further includes a sample transport system configured to transport the first sample carrier via a plurality of interconnected track segments to and from the first module. The system further includes a system controller comprising a processor and programming instructions executable thereon to (a) communicate via the first communication channel with the first sample carrier and the first module, (b) select and direct the first module to perform the action on the first sample container or a liquid contained therein, and (c) direct the first sample carrier via the sample transport system to and from the first module. The system still further includes a second controller that comprises a processor and programming instructions executable thereon to (a) communicate via the second communication channel with the first sample carrier and the first module, (b) in response to a detected fault adversely affecting transport of the first sample carrier or performance of the action by the first module, communicate via the second communication channel with at least one of a second sample carrier, a track segment, or a second module to obtain information therefrom to determine a work-around to the detected fault, and (c) in response to the communication, issue commands to execute the work-around or notify the system controller that a work-around has not been determined.

In some embodiments, a method of operating an automated diagnostic analysis system is provided. The method includes a system controller selecting and directing, via a first communication channel, a first module to perform an action on a first sample container or a liquid contained therein. The method also includes the system controller directing, also via the first communication channel, a first sample carrier to the first module via a sample transport system. The sample transport system comprises a plurality of interconnected track segments, and the first sample carrier transports the first sample container. The method further includes detecting a fault that adversely affects transport of the first sample carrier or performance of the action by the first module, wherein the detecting is performed by a sensor in the automated diagnostic analysis system. The method still further includes communicating, performed by a second controller using a second communication channel in response to detection of the fault, with at least one of a second sample carrier, a track segment, or a second module to obtain information therefrom to determine by the second controller a work-around to the fault. The method additionally includes issuing commands, performed by the second controller, to execute a determined work-around, or reporting to the system controller, performed by the second controller, that a work-around has not been determined.

Still other aspects, features, and advantages of this disclosure may be readily apparent from the following detailed description and illustration of a number of example embodiments and implementations, including the best mode contemplated for carrying out the invention. This disclosure may also be capable of other and different embodiments, and its several details may be modified in various respects, all without departing from the scope of the invention. For example, although the description below relates to automated diagnostic analysis systems, the integration of a second controller for local fault resolution with a system controller for system-wide workflow planning may be readily adapted to other complex systems. This disclosure is intended to cover all modifications, equivalents, and alternatives falling within the scope of the appended claims (see further below).

### BRIEF DESCRIPTION OF DRAWINGS

The drawings, described below, are for illustrative purposes and are not necessarily drawn to scale. Accordingly, the drawings and descriptions are to be regarded as illustrative in nature, and not as restrictive. The drawings are not intended to limit the scope of the invention in any way.

FIG. 1 illustrates a top schematic view of an automated diagnostic analysis system configured to perform one or more biological sample analyses according to embodiments provided herein.

FIG. 2 illustrates a side view of a sample container held in a sample carrier of the automated diagnostic analysis system of FIG. 1 according to embodiments provided herein.

FIG. 3 illustrates a top schematic view of a portion of the automated diagnostic analysis system of FIG. 1 according to embodiments provided herein.

FIGS. 4A and 4B each illustrates a top schematic view of a portion of the automated diagnostic analysis system of FIG. 1 according to embodiments provided herein.

FIG. 5 illustrates a top schematic view of a portion of a sample transport system track with sample carriers thereon in the automated diagnostic analysis system of FIG. 1 according to embodiments provided herein.

FIG. 6 illustrate a side schematic view of an aspirating/dispensing module of the automated diagnostic analysis system of FIG. 1 according to embodiments provided herein.

FIG. 7 illustrates a flowchart of a method of operating an automated diagnostic analysis system according to embodiments provided herein.

### DETAILED DESCRIPTION

Automated diagnostic analysis systems according to embodiments described herein may include a large number of sample carriers each carrying a sample container thereon. Each sample container may include a biological sample to be analyzed. The biological sample may be, e.g., urine, whole blood, blood serum, blood plasma, interstitial liquid, cerebrospinal liquid, and the like. Automated diagnostic analysis systems may also include a sample transport system for transporting the sample carriers throughout the system. The sample transport system may include a plurality of interconnected track segments. Automated diagnostic analysis systems may further include a number of modules for performing sample container handling, sample pre-processing, sample analysis, and sample post-processing. Each of the modules is connected to the sample transport system for receiving and returning sample containers via the sample carriers.

Automated diagnostic analysis systems may still further include a system controller in communication with the modules, the sample transport system, and the sample carriers. The system controller may plan the system's workflow. That is, the system controller may be operative to receive all relevant information, which may include the entire state of the system, and then schedule and direct one or more analyses of each sample in the sample containers to be performed at one or more of the modules within a particular time period. Such system controllers may be referred to as workflow planners. In some systems, the number of samples analyzed per day may number in the hundreds or even the thousands.

As samples are analyzed, one or more faults may occur, such as, e.g., a module malfunction, a sample carrier malfunction, a track segment malfunction, and/or sample carrier track congestion. Such localized faults may occur simultaneously or very close in time. In some known systems, the system controller may attend to resolution of each of these localized faults, typically by re-working the system's entire workflow plan as each fault is detected. Such fault resolution may significantly reduce the system controller's efficiency and may result in sample processing delays. Ultimately, the overall performance (e.g., the number of samples analyzed per hour, per shift, per day, etc.) of an automated diagnostic analysis system may be adversely affected.

Automated diagnostic analysis systems according to embodiments described herein may advantageously maintain high system performance by including decentralized processing capabilities apart from the system controller's function as a workflow planner. The decentralized processing capabilities may be implemented as one or more additional controllers configured to resolve localized faults detected during sample processing. Many such faults may be resolved by a work-around involving a small number of modules, sample carriers, and interconnected track segments around or near the location of the fault. Thus, such faults may be more efficiently resolved by, e.g., an additional controller instead of the system controller because the additional controller may not need to know the entire state of the system and may not need to re-work the entire system-wide workflow plan for resolution of each localized fault. The additional controller may only need to communicate with a small subset of system components within, e.g., a particular section or radius of the fault to determine a work-around. The additional controller may thus require less processing and memory resources than a system controller and may therefore be a cost-effective enhancement of an automated diagnostic analysis system by advantageously resolving various localized faults more efficiently while alleviating the workload on the system controller.

Furthermore, in those embodiments where more than one additional controller may be included, each additional controller may be configured to resolve faults detected within a particular section or radius of the automated diagnostic analysis system (e.g., a section that includes certain modules, interconnected track sections, and those sample carriers currently located therein). A particular section or radius of an additional controller may be preprogrammed in the additional controller or determined by, e.g., a communication range of the additional controller. Embodiments with multiple additional controllers may advantageously allow for parallel resolution of two or more concurrent faults occurring in different parts of the automated diagnostic analysis system by two or more of the additional controllers, thus allowing for a quicker return to full system performance.

Such decentralized processing by one or more additional controllers alleviates the system controller from resolving many types of localized faults, which advantageously allows the system controller to focus processing resources on system-wide issues and workflow planning. The integrated centralized and decentralized operation of automated diagnostic analysis systems may thus advantageously improve system performance.

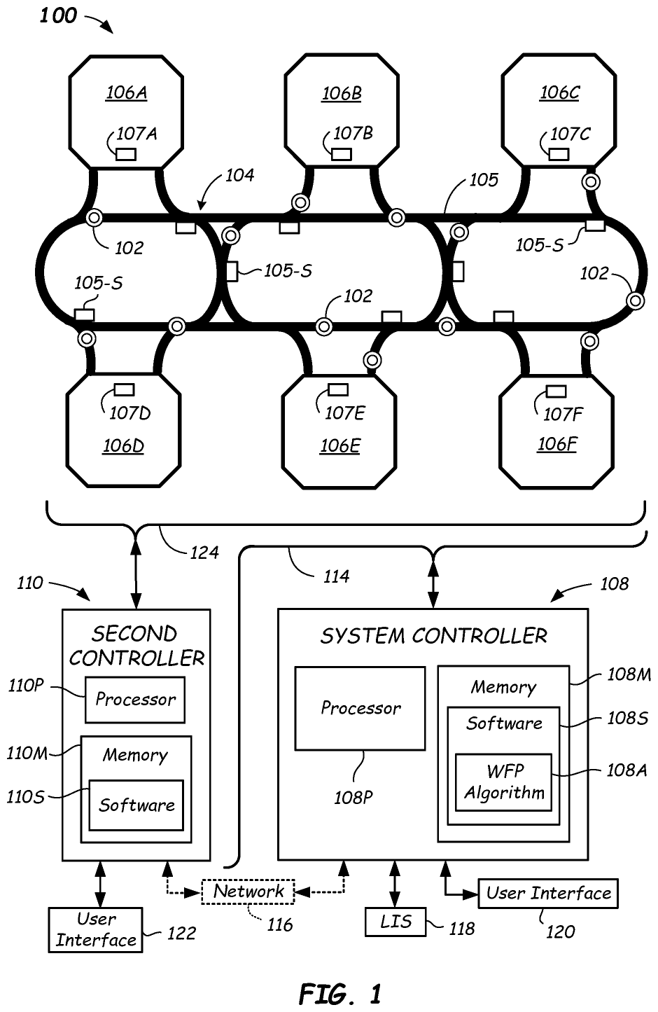

In accordance with one or more embodiments, automated diagnostic analysis systems having integrated centralized and decentralized operation will be explained in greater detail below in connection with FIGS. 1-7.

FIG. 1 illustrates an automated diagnostic analysis system 100 configured to automatically analyze biological samples according to one or more embodiments. Automated diagnostic analysis system 100 may include a plurality of sample carriers 102 (only three labeled in FIG. 1 to maintain clarity), a sample transport system 104 that includes an automated track 105 and track sensors 105-S (only three labeled), a plurality of modules 106A-F each including a respective module sensor 107A-F, a system controller 108, and decentralized processing capabilities implemented in some embodiments as one or more second controllers 110 (only one shown). Note that modules 106A-F, while illustrated as all having the same size and shape are not limited to all having the same size and/or shape. Automated diagnostic analysis system 100 may include more or less modules and/or other components.

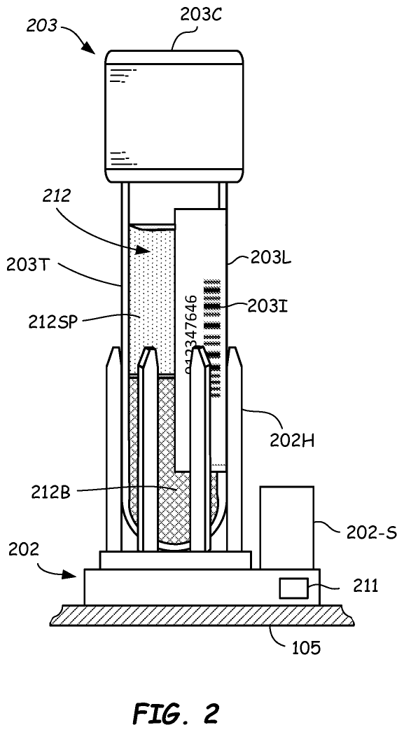

Each sample carrier 102 may be configured to carry one or more sample containers thereon. FIG. 2 illustrates a sample container 203 carried in a sample carrier 202, which is an embodiment of sample carrier 102. In some embodiments, sample carrier 202 may be a passive, non-motorized puck configured to carry a single sample container 203 on automated track 105 (via, e.g., a magnet in sample carrier 202) of sample transport system 104. In other embodiments, sample carrier 202 may be an automated carrier including an onboard drive motor, such as a linear motor, that is programmed via system controller 108 to move about the track and stop at preprogrammed locations (e.g., one or more of modules 106A-F). Sample carrier 202 may include a holder 202H configured to hold sample container 203 in a defined upright position and orientation. Holder 202H may include a plurality of fingers or leaf springs that secure sample container 203 in and on sample carrier 202, wherein some fingers or leaf springs may be moveable or flexible to accommodate different sizes of sample containers. Sample carrier 202 may also include a transceiver 211 for communicating with system controller 108, second controller 110, and other components in system 100. Sample carrier 202 may further include and one or more sensors 202-S, which in some embodiments may be a camera and/or a collision or position sensor. Other types of sensors may be included. Sensor 202-S may be used to detect faults as sample carrier 202 is transported through automated diagnostic analysis system 100. Such faults may include, e.g., track segment malfunctions, traffic congestion, possible collisions with other sample carriers, component misalignment, etc. Sensor 202-S may also be used to facilitate a work-around to a detected fault, such as, e.g., determining an alternate route to a selected module and/or correcting an aspiration/dispensing misalignment, as described in more detail below. Other types and/or configurations of sample carrier 202 may be used, and system 100 may include multiple types or configurations of sample carriers.

Sample container 203 may include a cap 203C, a tubular body 203T, and a label 203L, which may include identification information 2031 (e.g., indicia) thereon, such as a barcode, alphabetic characters, numeric characters, or combinations thereof. The identification information 2031 may be machine readable at various locations within automated diagnostic analysis system 100, such as, e.g., at each of modules 106A-F and at various locations around automated track 105 where sensors 105-S are located. A biological sample 212 to be analyzed may be contained in sample container 203. The biological sample may be, e.g., urine, whole blood, blood serum, blood plasma, interstitial liquid, cerebrospinal liquid, or the like. In some embodiments, as shown in FIG. 2, biological liquid sample 212 may include a blood serum or plasma portion 212SP and a settled blood portion 212B.

Returning to FIG. 1, sample transport system 104 may be configured to transport sample containers to and from each of modules 106A-F via respective sample carriers 102 and track 105. Track 105 may include multiple interconnected sections configured to allow unidirectional or bidirectional sample container transport. Track 105 may be a railed track (e.g., a monorail or multi-rail), a collection of conveyor belts, conveyor chains, moveable platforms, or any other suitable type of conveyance mechanism. Track 105 may be circular, oval, or any other suitable shape or configuration and combinations thereof and, in some embodiments, may be a closed track.

Modules 106A-F may each be configured to perform one or more actions on a sample container or a liquid contained in the sample container. In particular, one or more modules 106A-F may be configured to perform sample container handling, sample pre-processing, sample analysis, or sample post-processing.

For example, module 106A may be an input/output module where sample containers may be received in and removed from automated diagnostic analysis system 100. Module 106A may include, e.g., one or more compartments each configured/sized to receive a rack or tray of sample containers. Module 106A may also include a sensor (which may be sensor 107A) and robotics (not shown), wherein the robotics may be configured to grasp and move each sample container and the sensor may be configured to detect sample containers and to guide the robotics accordingly.

In another example, module 106B may be a quality check module where sample quality is checked before any sample processing takes place. In particular, module 106B may be configured to perform, e.g., an HILN determination. An HILN determination identifies whether an interferent, such as hemolysis (H), icterus (I), and/or lipemia (L), which may adversely affect sample analysis results, is present in a sample to be analyzed, or whether the sample is normal (N) and can be further processed. Module 106B may include one or more image capture devices for capturing images of a sample container at different angles. The images may then be analyzed by a processor or controller at module 106B (or elsewhere) to determine HILN.

In addition to input/output or quality check modules, one or more of modules 106A-F may be a pre-processing, analyzer, or post-processing module configured to perform one or more of, e.g., barcode reading; container imaging; container characterization (e.g., identifying the type and size of the sample container); sample characterization (e.g., identifying different portions of a liquid sample); fluid level determination; container decapping; sample temperature checking; sample centrifuging; pipetting actions (e.g., aspirating/dispensing and/or mixing of a sample with reagents, diluents, and/or other liquids); chemical analyses, immunoassay analyses, and/or hematological analyses (other types of analyses may alternatively or additionally be performed by modules 106A-F); container recapping, sample refrigeration; and/or sample storage. Modules 106A-F may each include one or more sensors 107A-F, such as, e.g., temperature, imaging, acoustic, vibration, pressure, voltage, collision, tactile, and/or proximity sensors as needed to carry out the module's function(s).

System controller 108 may be in communication with each of sample carriers 102, sample transport system 104, and modules 106A-F, each of which includes suitable communications apparatus (e.g., transceivers), via a first communication channel 114 either directly via wired and/or wireless connections as shown or via a network 116. Network 116 may be, e.g., a local area network (LAN), wide area network (WAN), or other suitable communication network, including wired and wireless networks. System controller 108 may be housed as part of automated diagnostic analysis system 100 or may be remote therefrom.

System controller 108 may be in communication with one or more databases or like sources, represented in FIG. 1 as a laboratory information system (LIS) 118 for receiving sample information including, e.g., one or more of patient information, analyses to be performed on each sample, time and date each sample was obtained, medical facility information, tracking and routing information, and/or any other information relevant to the samples to be analyzed.

System controller 108 may include a user interface 120, which may include a display, to enable a user to access a variety of control and status display screens and to input commands and/or data into system controller 108.

System controller 108 may also include a processor 108P, memory 108M, and programming instructions 108S (e.g., software, programs, algorithms, and the like). Programming instructions 108S may be stored in memory 108M and executed by processor 108P. A workflow planning (WFP) algorithm 108A also may be stored in memory 108M and executed by processor 108P. Memory 108M may further have one or more artificial intelligence (AI) algorithms stored therein to perform or facilitate various pre- and post-processing actions and/or sample analyses. System controller 108 may alternatively or additionally include other processing devices/circuits (including microprocessors, A/D converters, amplifiers, filters, etc.), transceivers, interfaces, device drivers, and/or other electronics.

System controller 108 may be configured to operate and/or control the various components of system 100, including sample carriers 102, sample transport system 104, and modules 106A-F via communication therewith over first communication channel 114. In particular, e.g., system controller 108 may control movement of each sample carrier 102 to and from any of modules 106A-F and to and from any other components (not shown) in system 100 via sample transport system 104. System controller 108 may plan the workflow of system 100 based on information received from, e.g., LIS 118 and/or user interface 120. That is, system controller 108 may be operative to schedule and direct one or more analyses of each sample contained in a respective sample container 102 to be performed on a particular time schedule at one or more of modules 106A-F. System controller 108 may be considered a workflow planner.

The one or more second controllers 110 (only one shown) may be in communication with each of, or a respective subset of (if system 100 includes more than one second controller 110), sample carriers 102, sample transport system 104, and modules 106A-F via a second communication channel 124 either directly via wired and/or wireless connections as shown or via network 116. Second controller 110 may include a processor 110P, memory 110M, and programming instructions 110S (e.g., software, programs, algorithms, and the like). Programming instructions 110S may be stored in memory 110M and executable by processor 110P. Second controller 110 also may include a user interface 122, which may include a display, to enable a user to access a variety of control and status display screens and to input commands and/or data into second controller 110.

Second controller 110 may be configured to receive reports of detected faults via second communication channel 124 from one or more of the sample carriers 102, sample transport system 104, and modules 106A-F. The faults may be detected by one or more sensors of a sample carrier 102, sample transport system 104, and/or modules 106A-F. A reported fault may be any condition that adversely affects transport of a sample carrier 102 or performance of an action by a module 106A-F on a sample container 203 (or a liquid contained therein) carried by a sample carrier 102 or 202. Faults may include, e.g., a module malfunction, a sample carrier malfunction, a track segment malfunction, a component misalignment issue, and/or sample carrier track congestion. In some embodiments, faults reported to second controller 110 may be forwarded by second controller 110 (or directly by sensors, etc.) to system controller 108 for future workflow planning and possible maintenance scheduling by system controller 108. Such fault communications to system controller 108 may be performed asynchronously.

Second controller 110 may also be configured to respond to receiving a reported fault by communicating via second communication channel 124 with one or more sample carriers 102, one or more track segments of sample transport system 104, and/or one or more of modules 106A-F around and/or near the location of the reported fault to determine a work-around to the fault. That is, second controller 110 includes module communication protocols for communicating with modules 106A-F, sample container communication protocols for communicating with sample containers 102, and sample transport system protocols for communicating with track segments of sample transport system 104, each via second communication channel 124. In some embodiments, second controller 110 may communicate via second communication channel 124 with one or more modules to obtain information regarding a module's functional capabilities, operating status, or availability to perform an action. In some embodiments, second controller 110 may communicate via the second communication channel 124 with one or more sample carriers to obtain information regarding a sample carrier's position, velocity, target destination, or availability to receive a sample container. And in some embodiments, second controller 110 may communicate via second communication channel 124 with one or more track segments (including switches thereof) of sample transport system 104 to obtain information regarding the operational status thereof.

Second controller 110 may initiate communication with one or more sample carriers 102, one or more track segments of sample transport system 104, and/or one or more of modules 106A-F within a particular radius or perimeter around and/or near the location of the reported fault. In some embodiments, second controller 110 may expand that radius or perimeter to include additional sample carriers 102, additional track segments of sample transport system 104, and/or additional modules 106A-F in cases where more information is needed to determine a work-around to the fault.

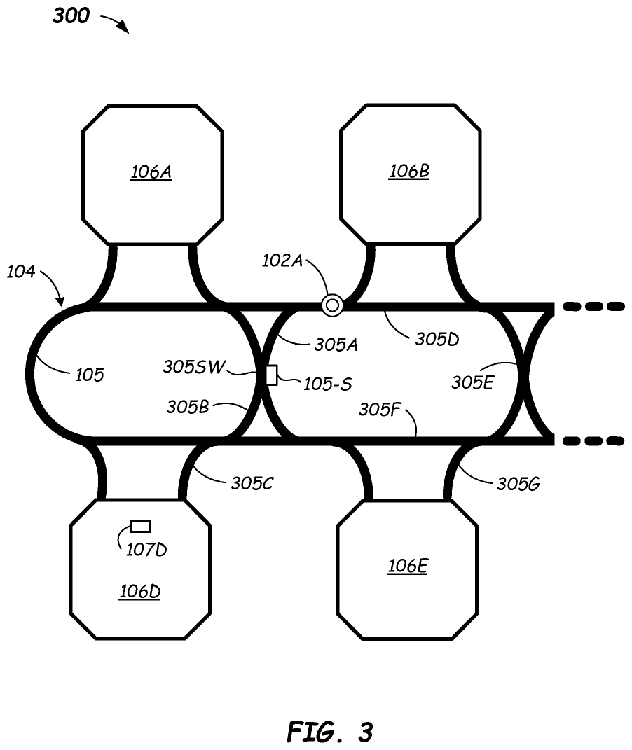

In one example according to one or more embodiments, FIG. 3 shows a portion 300 of system 100 that includes a sample carrier 102A, which has been scheduled and directed by system controller 108 to proceed from module 106B to module 106D via track segments 305A, 305B, and 305C of track 105. However, a track segment malfunction has occurred at track switch 305SW. Track switch 305SW switches sample carriers between track segments 305A and 305B. The malfunction prevents sample carrier 102A from switching to track segment 305B from track segment 305A. One or more sensors (e.g., sensor 105-S of sample transport system 104 and/or sensor 202-S carried by sample carrier 102A) may report this fault to second controller 110 via second communication channel 124. In response to receiving notification of the track segment malfunction, second controller 110 may communicate via second communication channel 124 with, e.g., nearby sample carriers (none in this case) and/or other track segments, such as track segments 305D, 305E, and 305F to determine their functional status. Note that portion 300 may represent a predetermined radius or section around sample carrier 102A within which second controller 110 initiates communications. In response to receiving the requested status, second controller 110 may determine a work-around to the track segment malfunction and accordingly issue commands to sample carrier 102A and/or sample transport system 104 to reroute sample carrier 102A to module 106D via, e.g., track segments 305D, 305E, 305F, and 305C.

In another example according to one or more embodiments, referring again to FIG. 3, sample carrier 102A has again been scheduled and directed by system controller 108 to proceed from module 106B to module 106D. However, a module malfunction has occurred at module 106D. The malfunction prevents sample carrier 102A from being processed at module 106D and may be reported to second controller 110 by module sensor 107D via second communication channel 124. In response to receiving notification of the module malfunction, second controller 110 may communicate via second communication channel 124 with, e.g., nearby modules 106A and 106E to determine whether they can perform the same function as module 106D and whether they are available to perform that function. In response to receiving the requested information, second controller 110 may issue commands instructing module 106E, which has indicated that it can perform the same function as module 106D and is available to do so, to perform that function on sample carrier 102A. Second controller 110 may also issue commands to sample carrier 102A and/or sample transport system 104 to reroute sample carrier 102A to module 106E via track segments 305D, 305E, 305F, and 305G. Note that in the event that neither of modules 106A or 106E responds satisfactorily to second controller 110, second controller 110 may communicate via second communication channel 124 with a next nearest group of modules to find one capable of and available to perform the same function as malfunctioning module 106D.

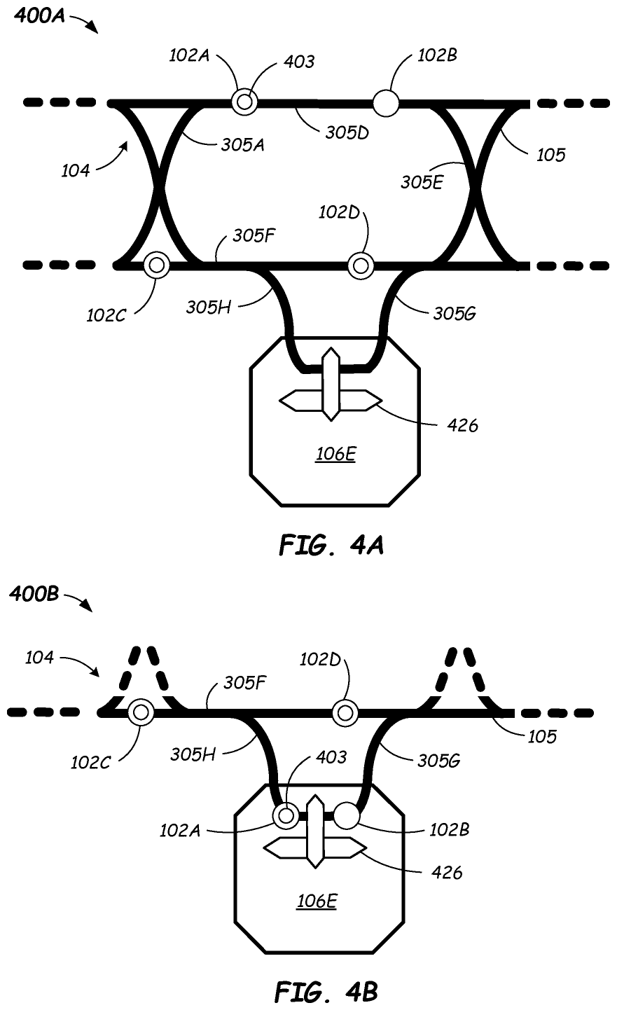

In a further example according to one or more embodiments, FIGS. 4A and 4B show respective portions 400A and 400B of system 100 that includes sample carrier 102A carrying a sample container 403. Sample carrier 102A may experience a malfunction and may report that carrier malfunction to second controller 110 via second communication channel 124. The carrier malfunction may be detected by an on-board sensor (e.g., sensor 202-S), which may be, e.g., a vibration sensor that has detected excessive vibration as the sample carrier moves on track 105 (possibly caused by a mechanical problem with sample carrier 102A). In response to receiving the malfunction report, second controller 110 may communicate via second communication channel 124 with nearby sample carriers to determine if any are available to receive a sample container. Second controller 110 may also communicate via second communication channel 124 with nearby modules to determine if any have robotics for handling sample containers. Note that portion 400A may represent a predetermined radius or section around sample carrier 102A within which second controller 110 initiates communications. In response to receiving information that, e.g., sample carrier 102B is available to receive a sample container and that module 106E has robotics 426 for handling sample containers, second controller 110 may issue commands via second communication channel 124 directing sample carrier 102A to module 106E via track segments 305A, 305F, and 305H and directing sample carrier 102B to module 106E via track segments 305E and 305G, as shown in FIG. 4B. Second controller 110 may also issue commands via second communication channel 124 instructing module 106E to transfer sample container 403 from sample carrier 102A to sample carrier 102B using robotics 426. Upon completion of the transfer, second controller 110 may further issue commands via second communication channel 124 directing sample carrier 102A to an input/output module (e.g., module 106A) for removal from system 100.

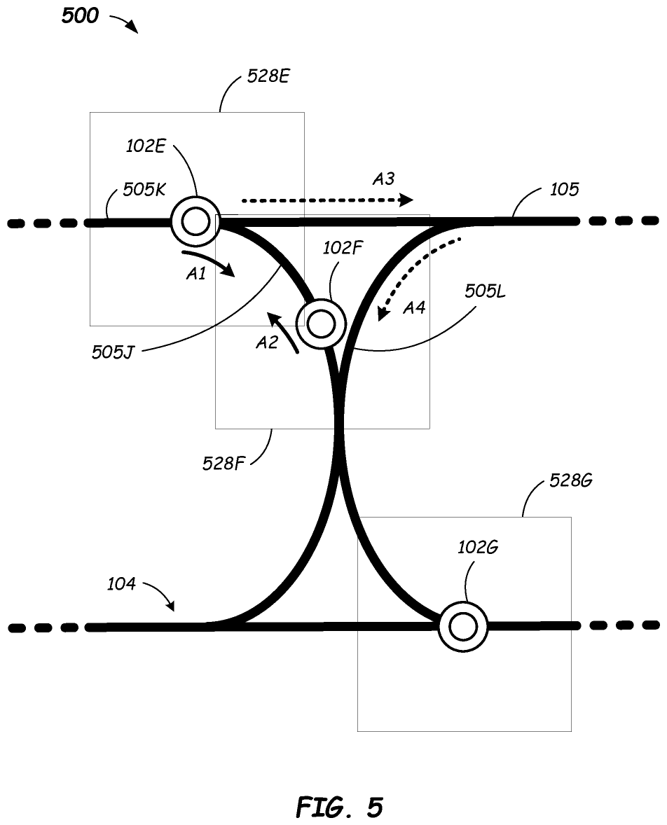

In a still further example according to one or more embodiments, FIG. 5 shows a portion 500 of track 105 of sample transport system 104 that has sample carriers 102E, 102F, and 102G thereon. Each of sample carriers 102E, 102F, and 102G may include a collision sensor (not shown) or other like sensor which creates a respective field of view (“FOV”)” around each sample carrier. That is, anything entering an FOV is detected by the collision sensor. As shown, sample carrier 102E has an FOV 528E, sample carrier 102F has an FOV 528F, and sample carrier 102G has an FOV 528G. Sample carrier 102E may have been assigned a sequence of module visits by system controller 108 that includes proceeding to a particular module via track segment 505J in the direction indicated by arrow A1. Sample carrier 102F may have been assigned a sequence of module visits by system controller 108 that includes proceeding to a different module also via track segment 505J but in the direction indicated by arrow A2. Due to timing or sample processing delays or other issues, e.g., carriers 102E and 102F may inadvertently end up approaching each other as shown. As one or both of sample carriers 102E and/or 102F enters the other's FOV 528E and/or FOV 528F, an impending collision fault may be reported to second controller 110 via second communication channel 124 by either or both of the collision sensors of sample carriers 102E and/or 102F. In response, second controller 110 may communicate via second communication channel 124 with sample transport system 104 and/or sample carriers 102E and 102F to halt transport of both sample carriers 102E and 102F. Second controller 110 may also communicate via second communication channel 124 with both of sample carriers 102E and 102F to obtain information indicating each's next assigned module and scheduled arrival time thereat, and then determine a bypass maneuver (i.e., a work-around) to avoid the impending collision. For example, second controller 110 may receive information from sample carriers 102E and 102F that sample carrier 102F is scheduled to arrive at its next assigned module before the scheduled arrival time of sample carrier 102E at its next assigned module. Second controller 110 may then issue reroute commands via second communication channel 124 to sample carrier 102E and sample transport system 104 to keep sample carrier 102E on track segment 505K (as indicated by arrow A3) instead of switching onto track segment 505J, thus avoiding a collision with sample carrier 102F. Sample carrier 102E may then reverse direction to be switched from track segment 505K onto track segment 505L (as indicated by arrow A4) and then switched onto the lower portion of track segment 505J to complete its transport as originally directed.

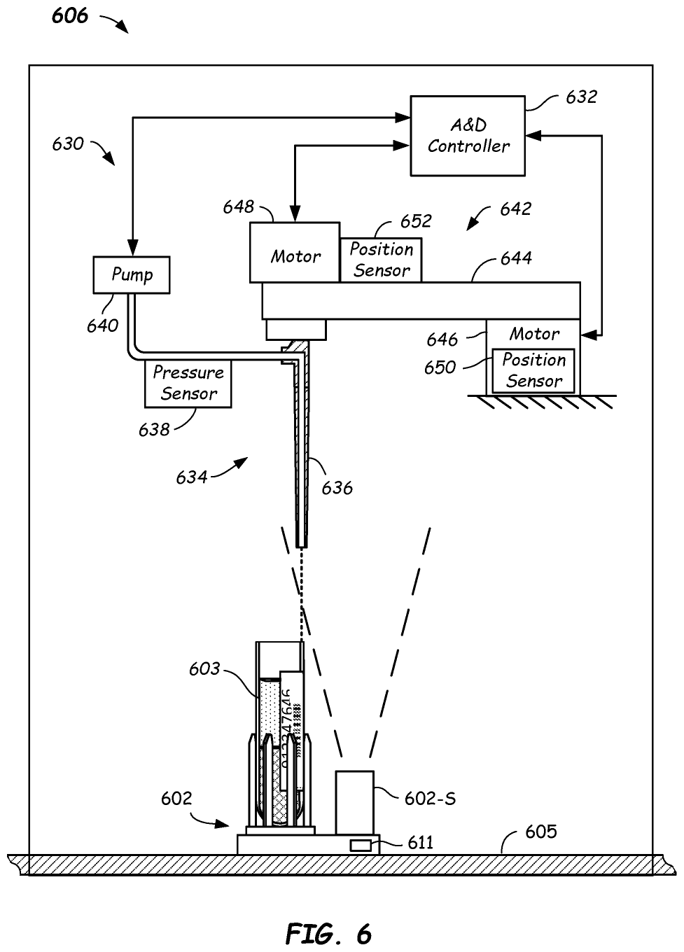

In yet another example according to one or more embodiments, FIG. 6 shows a module 606 configured to perform aspirating/dispensing functions. Module 606 may include aspirating/dispensing apparatus 630 electrically coupled to an aspirating/dispensing controller 632. Aspirating/dispensing apparatus 630 may include a pipette assembly 634 that includes a probe 636, a pressure sensor 638, and a pump 640 operative to dispense a liquid (e.g., a reagent, diluent, biological liquid sample, etc.) into a reaction vessel or other container (not shown), or aspirate a liquid (e.g., a reagent, diluent, biological liquid sample, etc.) from a container, such as, e.g., a biological liquid sample from a sample container 603 as shown. Aspirating/dispensing apparatus 630 may also include robotics 642 configured to move pipette assembly 634 within module 606. Robotics 642 may include one or more arms 644, motors 646 and 648, and position sensors 650 and 652 for moving probe 636 in three dimensions (e.g., in an X, Y, Z coordinate system). Aspirating/dispensing apparatus 630 may include other components. Aspirating/dispensing controller 632 may include a processor, a transceiver and/or other communication interface(s), a memory, and programs/algorithms stored in the memory (none shown) that are executable by the processor. Aspirating/dispensing controller 632 may be operative to receive instructions from system controller 108 (FIG. 1) and/or user interface 120, and inputs from pressure sensor 638, position sensors 650 and 652, and any other sensors in module 606. Aspirating/dispensing controller 632 may also be operative to control and monitor components within module 606 via execution of the stored programs/algorithms based on the received instructions and inputs to perform various aspirating/dispensing functions on containers, reaction vessels, and the like that enter module 606 via a track segment 605 of track 105 (FIG. 1).

A sample carrier 602, which is an embodiment of sample carrier 102 and has been directed by system controller 108 (FIG. 1) to arrive at module 606, is shown positioned within module 606 at coordinates assigned by system controller 108. The coordinates should result in an alignment of probe 636 with sample container 603, which is carried by sample carrier 602. In some cases, however, the alignment coordinates provided by system controller 108 may be outdated (due to, e.g., a component that drifts out-of-spec because of, e.g., mechanical wear or failure or an environmental issue such as, e.g., dust/dirt affecting the operation of, e.g., a servomechanism in sample transport system 104). Inaccurate coordinates may result in a misalignment between probe 636 and sample container 603, as shown in FIG. 6, wherein probe 636 could damage sample container 603 during an aspirating/dispensing function. Such a misalignment fault may be detected by a sensor 602-S of sample carrier 602. Sensor 602-S may be, e.g., a camera or a proximity or position sensor directed upward as shown. In response to sensor 602-S detecting the misalignment fault, sample carrier 602 may communicate the detected fault to second controller 110 via a transceiver 611 and second communication channel 124. In response, second controller 110 may issue commands via second communication channel 124 instructing module 606 to halt the aspirating/dispensing function. Second controller 110 may process the data from sensor 602-S and resolve the misalignment issue by determining and communicating a position adjustment to module 606 (aspirating/dispensing controller 632) via second communication channel 124 such that probe 636 is re-positioned and aligned with sample container 603. Second controller 110 may further communicate the position adjustment to system controller 108 via the first communication channel 114 to avoid misalignment issues in module 606 in future commands issued by system controller 108.

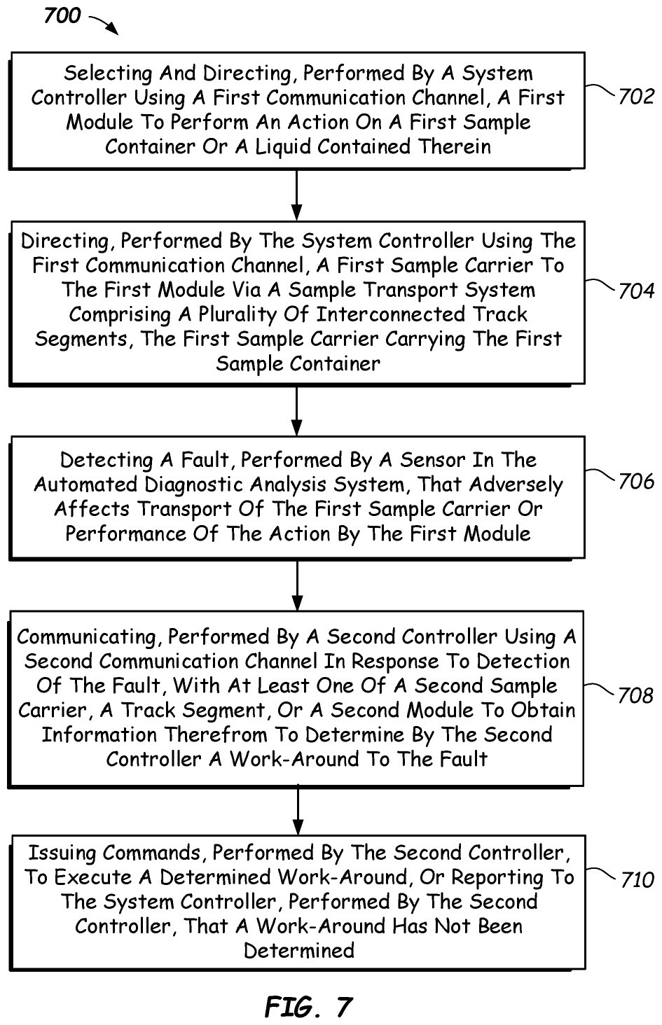

FIG. 7 illustrates a method 700 of operating an automated diagnostic analysis system according to one or more embodiments. At process block 702, method 700 may begin with a system controller selecting and directing, via a first communication channel, a first module to perform an action on a first sample container or a liquid contained therein. For example, the system controller may be system controller 108 (FIG. 1), the first module may be any one of modules 106A-F or 606, and the first sample container may be sample container 203 (FIG. 2) or 603 (FIG. 6). The action may be any one of the sample container handling, sample pre-processing, sample analysis, or sample post-processing actions described above in connection with modules 106A-F and 606.

At process block 704, method 700 may include the system controller directing, via the first communication channel, transport of a first sample carrier to the first module via a sample transport system comprising a plurality of interconnected track segments, wherein the first sample carrier carries the first sample container. For example, the first sample carrier may be, e.g., any one of sample carriers 102 (FIG. 1), 202 (FIG. 2), or 602 (FIG. 6), and the sample transport system may be sample transport system 104 (FIG. 1) comprising track segments 305A-G (FIG. 3).

At process block 706, method 700 may include a sensor in the automated diagnostic analysis system detecting a fault, wherein the fault adversely affects transport of the first sample carrier or performance of the action by the first module. For example, the first module may be module 106D, the sensor may be sensor 107D, and the fault may be a module malfunction as described above in connection with FIG. 3.

At process block 708, method 700 may include a second controller communicating, via a second communication channel in response to detection of the fault, with at least one of a second sample carrier, a track segment, or a second module to obtain information therefrom to determine by the second controller a work-around to the fault. Continuing with the above example in connection with FIG. 3, second controller 110 may communicate via second communication channel 124 with modules 106A and 106E to determine whether they can perform the same function as malfunctioning module 106D and whether they are available to do so.

And at process block 710, method 700 may include the second controller issuing commands to execute a determined work-around, or the second controller reporting to the system controller that a work-around has not been determined. Continuing again with the above example in connection with FIG. 3, second controller 110 may instruct module 106E, which has indicated that it can perform the same function as module 106D and is available to do so, to perform that function on sample carrier 102A. Second controller 110 may also reroute sample carrier 102A to module 106E via track segments 305D, 305E, 305F, and 305G.

Note that while the decentralized processing capabilities of resolving detected faults in automated diagnostic analysis system 100 as described herein may be implemented in one or more second controllers 110 in some embodiments, the decentralized processing capabilities may be implemented in other embodiments in one or more suitably configured processors or controllers of modules of system 100, such as, e.g., aspirating/dispensing controller 632 (FIG. 6). In still other embodiments, the decentralized processing capabilities may be implemented in one or more other processors (not shown) of system controller 108, wherein those other processors do not affect processor 108P. Other suitable implementations of providing the decentralized processing capabilities of resolving detected faults are possible.

While this disclosure is susceptible to various modifications and alternative forms, specific method and apparatus embodiments have been shown by way of example in the drawings and are described in detail herein. It should be understood, however, that the particular methods and apparatus disclosed herein are not intended to limit the disclosure or the following claims.

What is claimed is:

1. An automated diagnostic analysis system, comprising:
a first sample carrier operative to communicate using a first communication channel and a second communication channel and configured to carry a first sample container;
a first module operative to communicate using the first communication channel and the second communication channel and configured to perform an action on a sample container or a liquid contained in the sample container;
a sample transport system configured to transport the first sample carrier via a plurality of interconnected track segments to and from the first module;
a system controller comprising a processor and programming instructions executable thereon to:
communicate via the first communication channel with the first sample carrier and the first module,
select and direct the first module to perform the action on the first sample container or a liquid contained therein, and
direct the first sample carrier via the sample transport system to and from the first module; and
a second controller comprising a processor and programming instructions executable thereon to:
communicate via the second communication channel with the first sample carrier and the first module,
in response to a detected fault adversely affecting transport of the first sample carrier or performance of the action by the first module, communicate via the second communication channel with at least one of a second sample carrier, a track segment, or a second module to obtain information therefrom to determine a work-around to the detected fault, and
in response to the communication, issue commands to execute the work-around or notify the system controller that a work-around has not been determined.

2. The automated diagnostic analysis system of claim 1, wherein the second sample carrier or the second module is within a predetermined radius around the first sample carrier.

3. The automated diagnostic analysis system of claim 1, wherein the detected fault comprises one of a module malfunction, a module not-available status, a track segment malfunction, a component misalignment issue, sample carrier traffic congestion, and a sample carrier malfunction.

4. The automated diagnostic analysis system of claim 1, wherein the first sample carrier further comprises one or more sensors configured to detect the detected fault or to facilitate determining a work-around to the detected fault.

5. The automated diagnostic analysis system of claim 1, wherein the issue commands to execute the work-around comprises the second controller directing the first sample carrier to the first module via an alternative route in the sample transport system, directing the first sample carrier to the second module via the sample transport system, directing the second module to perform the action on the first sample container or the liquid contained therein, or directing the first sample container to be transferred from the first sample carrier to the second sample carrier.

6. The automated diagnostic analysis system of claim 1, wherein the issue commands to execute the work-around comprises the second controller directing an alignment of a component with respect to the first sample carrier.

7. The automated diagnostic analysis system of claim 6, wherein the issue commands to execute the work-around comprises the second controller directing an alignment of an aspiration/dispensing component with respect to the first sample container.

8. The automated diagnostic analysis system of claim 1, wherein the communication via the second communication channel with the at least a second sample carrier comprises obtaining the second sample carrier's position, velocity, target destination, or availability to receive a sample container.

9. The automated diagnostic analysis system of claim 1, wherein the communication via the second communication channel with the at least a second module comprises obtaining the second module's functional capabilities, operating status, or availability to perform the action.

10. The automated diagnostic analysis system of claim 1, wherein the action comprises centrifuging, decapping, aspiration/dispensing, pre-sample analysis, sample analysis, post-sample analysis, recapping, refrigeration, or storage.

11. The automated diagnostic analysis system of claim 1, wherein the second controller reports the detected fault and the work-around to the system controller via the first communication channel.

12. A method of operating an automated diagnostic analysis system, the method comprising:
selecting and directing, performed by a system controller using a first communication channel, a first module to perform an action on a first sample container or a liquid contained therein;
directing, performed by the system controller using the first communication channel, a first sample carrier to the first module via a sample transport system comprising a plurality of interconnected track segments, the first sample carrier carrying the first sample container;
detecting a fault, performed by a sensor in the automated diagnostic analysis system, the fault adversely affecting transport of the first sample carrier or performance of the action by the first module;
communicating, performed by a second controller using a second communication channel in response to detection of the fault, with at least one of a second sample carrier, a track segment, or a second module to obtain information therefrom to determine by the second controller a work-around to the fault; and
issuing commands, performed by the second controller, to execute a determined work-around, or
reporting to the system controller, performed by the second controller, that a work-around has not been determined.

13. The method of claim 12, wherein the first sample carrier, a track segment, or the first module comprises the sensor.

14. The method of claim 12, wherein the fault comprises one of a module malfunction, a module not-available status, a track segment malfunction, a component misalignment issue, sample carrier traffic congestion, and a sample carrier malfunction.

15. The method of claim 12, wherein the communicating comprises communicating with at least:
the second sample carrier to obtain the second sample carrier's position, velocity, target destination, or availability status to receive a sample container; or
the second module to obtain the second module's functional capabilities, operating status, or availability to perform the action.

16. The method of claim 12, further comprising determining the work-around in response to the communicating, performed by the second controller using the second communication channel, to include one or more of:
directing transport of the first sample carrier to the first module via an alternative route in the sample transport system;
directing transport of the first sample carrier to the second module via the sample transport system;
directing the second module to perform the action on the first sample container or the liquid contained therein;
directing the first sample container to be transferred from the first sample carrier to the second sample carrier; or
directing an alignment of a component with respect to the first sample carrier.

17. The method of claim 16, wherein the directing the alignment comprises directing the alignment of an aspiration/dispensing component with respect to the first sample container.

18. The method of claim 12, further comprising reporting, performed by the second controller using the first communication channel, the fault and the work-around to the system controller.

19. The method of claim 12, wherein the second sample carrier or the second module is within a predetermined radius around the first sample carrier.

20. The method of claim 12 wherein the action comprises centrifuging, decapping, aspiration/dispensing, pre-sample analysis, sample analysis, post-sample analysis, recapping, refrigeration, or storage.
